(19) United States
(12) Patent Application Publication
(10) Pub. No.: US 2010/0166183 A1
(43) Pub. Date: Jul. 1, 2010

(54) OPTIMIZING SECURITY BITS IN A MEDIA ACCESS CONTROL (MAC) HEADER

(76) Inventors: David Johnston, Beaverton, OR (US); Muthu Vankatachalam, Beaverton, OR (US)

Correspondence Address: INTEL CORPORATION;c/o CPA Global, P.O. BOX 52050, MINNEAPOLIS, MN, 55402, US

(21) Appl. No.: 12/347,872

(22) Filed: Dec. 31, 2008

(51) Int. Cl. H04L 9/08

(52) U.S. Cl. 380/270; 380/283

(57) ABSTRACT

A method of retrieving security information in a media access control (MAC) header by a wireless station may include receiving a data unit, such as a protocol data unit (PDU), from a remote wireless station. The PDU may include the MAC header. The method may also include reading two encryption key sequence (EKS) bits in the MAC header that denote both whether the data unit is encrypted and a position in an encryption key sequence for the data unit.

### BACKGROUND

Implementations of the claimed invention generally may relate to wireless communication, and in particular to security bits in media access control (MAC) headers.

Modern wireless data communication systems such as WiMAX, WiMAX-II, 3GPP LTE may be designed with security features included in their standard communication protocols. An example of this will be presented with regard to FIG. 1, which conceptually illustrates a wireless station (STA) 100, or communication module therein. STA 100 may be a base station (BS), a mobile station (MS), or some other type of node in a communication system or network. STA 100 may include a media access control (MAC) module 110, a physical layer (PHY) module 120, and an antenna 130. Although illustrated as separate module, MAC 110 and PHY 120 may in some implementations be implemented by the same processor and/or logic. Other typically present modules (e.g., higher communication layers) are purposely not illustrated for clarity of presentation, but may nonetheless be included in STA 100 if reasonably necessary for typical functionalities (e.g., features of a wireless protocol such as WiMAX, LTE, etc.) thereof.

MAC module 110 may generate data units, typically referred to as service data units when communicating with higher layers and protocol data units when communicating with lower layers (e.g., PHY module 120). One exemplary MAC data unit 140 is illustrated in FIG. 1, and it may include a MAC header 150, and optionally a payload and/or cyclic redundancy check (CRC). In some implementations, data unit 140 may be a MAC protocol data unit (MPDU), and header 150 may be a header thereof. Colloquially, header 150 may sometimes be referred to as a generic MAC header (GMH).

For security purposes, MAC header 150 typically may contain one encryption (EC) bit and two encryption key sequence (EKS) bits. The EC bit and the EKS bits need not be contiguous as long as they are in known positions in header 150. FIG. 2 illustrates possible state transitions of EC bit 210 and EKS bits 220. As is known, the state of EC bit 210 may indicate whether the payload of data unit 140 is encrypted or unencrypted (e.g., plaintext). In certain wireless protocols (e.g., WiMAX) there are overlapping encryption key updates, where while using one encryption key STA 100 may run a protocol to request the next encryption key in advance of receiving a data unit encrypted with such a key. EKS bits 220 may identify a current encryption key, and may also have directional state transitions (e.g., 00→01→10→11→00 as in FIG. 2) to enforce the forward application of new transient encryption keys (TEK) and to prevent old keys from being reused.

Because such thee bits of security information are transmitted for each data unit 140, however, it may contribute to the overhead of STA 100 and a corresponding reduction of bandwidth for any wireless system of which STA 100 is a part.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 conceptually illustrates a wireless station and associated data unit;

FIG. 2 illustrates possible state transitions of EC and EKS bits in a header;

FIG. 3 illustrates possible state transitions of EKS bits in a MAC header according to some implementations;

FIG. 4 shows a process of transmitting using the EKS bits of FIG. 3; and

FIG. 5 shows a process of receiving using the EKS bits of FIG. 3.

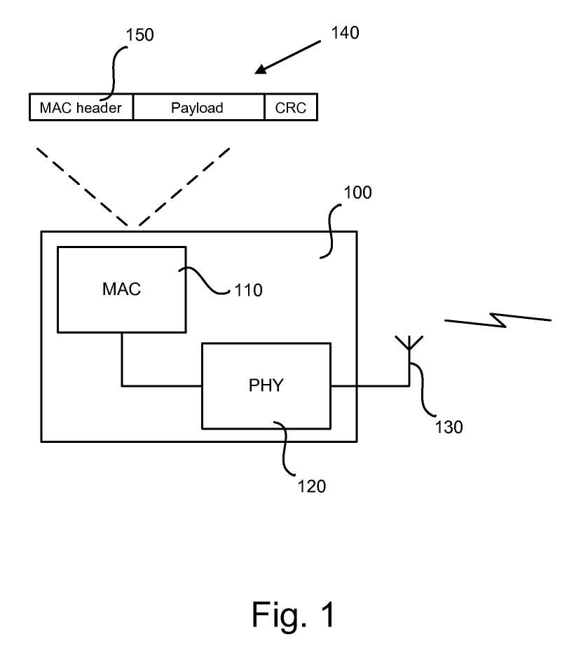

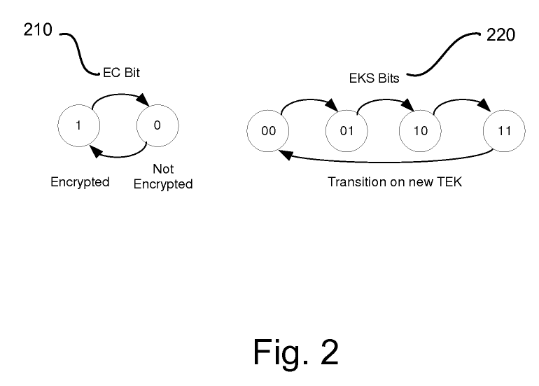

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art having the benefit of the present disclosure that the various aspects of the invention claimed may be practiced in other examples that depart from these specific details. In certain instances, descriptions of well known devices, circuits, and methods are omitted so as not to obscure the description of the present invention with unnecessary detail.

To decrease the potential size of MAC header 150, the scheme described herein may encode both 1) the forward state updates of encryption keys and 2) the encrypted state of the packet using only two bits (e.g., the two EKS bits). In such a scheme, the EC bit would not exist in header 150, assisting in an overall header size reduction (e.g., from a 6 byte GMH to 4 bytes). Such a header reduction may reduce overhead bandwidth and improve throughput in a wireless system, while maintaining both the encryption (EC) and encryption key sequence (EKS) functionalities described above.

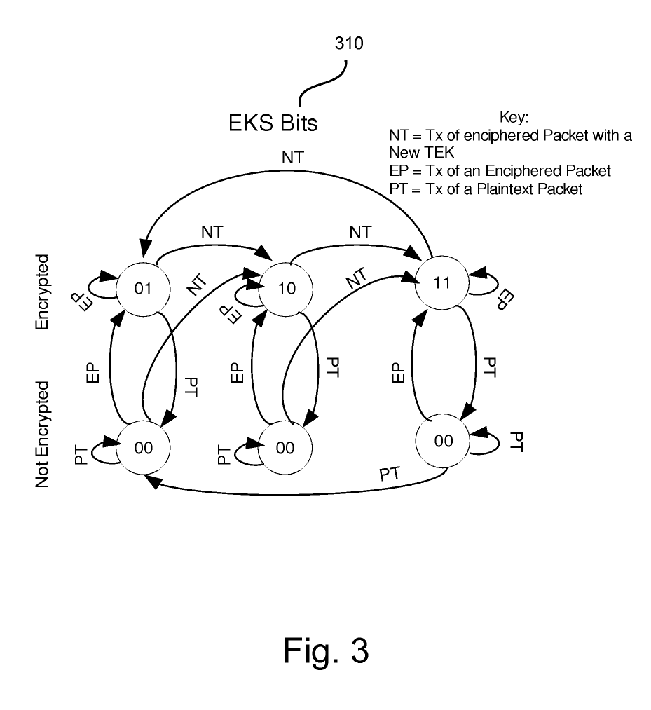

FIG. 3 illustrates possible state transitions of EKS bits 310 in a MAC header according to some implementations. Conceptually, of the four possible states represented by the two bits, one state may indicate when the data unit 140 (e.g., PDU) is not encrypted, and the other three states may be used for sequential key control when the data unit 140 is encrypted.

In the implementation shown in FIG. 3, state 00 for EKS bits 310 may indicate that the data unit is not encrypted, while states 01, 10, and 11 may indicate the key identifier (ID). In such an implementation, the key ID may only increment modulo 3, offset 1 (e.g., 01→10→11→01) in a valid forward path.

Other state transitions are also illustrate in FIG. 3. For completeness, the state transition NT denotes the transmission (Tx) (or reception Rx if STA 100 happens to be receiving PDU 140) of an encrypted packet with a new transient encryption key (TEK). The state transition EP denotes the Tx (or Rx if STA 100 happens to be receiving PDU 140) of an encrypted packet with the same TEK as the current state. Also, the state transition PT denotes the Tx (or Rx if STA 100 happens to be receiving PDU 140) of an unencrypted (e.g., plaintext) packet. The arrows shown in FIG. 3 indicate the permitted transitions among the various states of the two EKS bits.

It should be noted that the four states shown are only suggestions. Any other logical convention may be used to assign the one unencrypted state and the three EKS states. In other words, the unencrypted state need not be 00, but may be any of the other three states as long as the remaining states are assigned consistently with the description herein (e.g., as EKS states).

Referring again to FIG. 3, on each MPDU sent, the two EKS bits 310 would be examined for key encryption purposes. If the EKS bits 310 are 00, then the packet would be considered to be unencrypted and would be parsed as such. If the EKS bits 310 are not 00, then to be valid they should be either the same as the EKS bits of the last encrypted MPDU, or the next state along in the 01→10→11→01 permitted state transitions. Using this encoding, both the encrypted state of the MPDU can be indicated and the forward-only transition of the TEK keys used enforced, using only 2 bits (e.g., EKS bits 310, although such bits may of course be renamed with another identifier). This representation of two different pieces of information while removing one bit previously used to represent one of them may contribute to a reduced size MAC header 140.

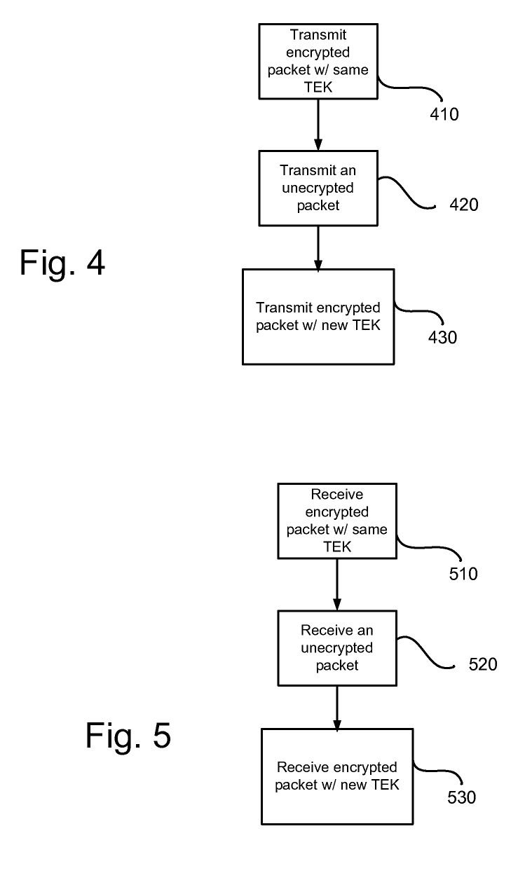

FIG. 4 shows a process of STA 100 transmitting using only the two EKS bits 310 as encryption state and key indicators. Processing may begin with STA 100 transmitting an encrypted packet with a same TEK [act 410]. Act 410 corresponds to state transition EP in FIG. 3, which may occur from any of states 01, 10, or 11 to itself. Thus act 410 may include transmitting a MAC header 150 (e.g., in MPDU 140) with the two EKS bits being non-zero and remaining the same as those in a prior transmission. Act 410 may also include encrypting the payload of the data unit 140 with the same TEK that was previously used before transmission.

Processing may continue with STA 100 transmitting an unencrypted packet [act 420]. Act 420 corresponds to state transition PT in FIG. 3, which may occur from any of states 00, 01, 10, or 11 to state 00. Thus act 420 may include transmitting a MAC header 150 (e.g., in MPDU 140) with the two EKS bits being 00.

Processing may continue with STA 100 transmitting an encrypted packet with a new TEK [act 430]. Act 430 corresponds to state transition NT in FIG. 3, which may occur from any of states 00, 01, 10, or 11 to a sequential, but different state 01, 10, or 11. Thus act 430 may include transmitting a MAC header 150 (e.g., in MPDU 140) with the two EKS bits being non-zero but different than those in a prior transmission as shown in FIG. 3. Act 430 may also include encrypting the payload of the data unit 140 with the new TEK before transmission.

It should be noted that although acts 410-430 are illustrated as happening in a particular order, this is purely for ease of explanation and is not limiting. Any of acts 410-430 may occur after any of the others, or after itself, as illustrated in the various state transition arrows of FIG. 3.

In contrast to FIG. 4 where STA 100 transmits, FIG. 5 illustrates a similar process where STA 100 receives only the two EKS bits 310 as encryption state and key indicators. Processing may begin with STA 100 receiving an encrypted packet with a same TEK [act 510]. Act 510 corresponds to state transition EP in FIG. 3, which may occur from any of states 01, 10, or 11 to itself. Thus act 510 may include receiving a MAC header 150 (e.g., in MPDU 140) with the two EKS bits being non-zero and remaining the same as those in a prior transmission. Act 510 may also include decrypting the payload of the data unit 140 with the same TEK that was previously used after reception of the packet.

Processing may continue with STA 100 receiving an unencrypted packet [act 520]. Act 520 corresponds to state transition PT in FIG. 3, which may occur from any of states 00, 01, 10, or 11 to state 00. Thus act 520 may include receiving a MAC header 150 (e.g., in MPDU 140) with the two EKS bits being 00.

Processing may continue with STA 100 receiving an encrypted packet with a new TEK [act 530]. Act 530 corresponds to state transition NT in FIG. 3, which may occur from any of states 00, 01, 10, or 11 to a sequential, but different state 01, 10, or 11. Thus act 530 may include receiving a MAC header 150 (e.g., in MPDU 140) with the two EKS bits being non-zero but different than those in a prior transmission as shown in FIG. 3. Act 530 may also include decrypting the payload of the data unit 140 with the new TEK after reception of the packet.

It should be noted that although acts 510-530 are illustrated as happening in a particular order, this is purely for ease of explanation and is not limiting. Any of acts 510-530 may occur after any of the others, or after itself, as illustrated in the various state transition arrows of FIG. 3.

Thus the scheme herein merges the indication of two separate things, encryption/non-encryption indication and encryption key sequence, in the MAC header into a pair of bits, saving one bit in a novel way.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the invention. For example, any or all of the acts in FIGS. 4 or 5 may be performed as a result of execution by a computer (or processor or dedicated logic) of instructions embodied on a computer-readable medium, such as a memory, disk, etc.

No element, act, or instruction used in the description of the present application should be construed as critical or essential to the invention unless explicitly described as such. Also, as used herein, the article “a” is intended to include one or more items. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method of providing security information in a media access control (MAC) header by a wireless station, comprising:
generating a data unit including the MAC header, the MAC header including:
two bits that denote both whether the data unit is encrypted and an encryption key sequence for the data unit; and
transmitting the data unit to a remote wireless station.

2. The method of claim 1, wherein the two bits are encryption key sequence (EKS) bits located in a predefined location within the MAC header.

3. The method of claim 1, wherein the MAC header does not include a separate encryption (EC) bit whose state denotes whether the data unit is encrypted.

4. The method of claim 1, wherein one of four possible states of the two bits indicates that the data unit is unencrypted.

5. The method of claim 1, wherein three of four possible states of the two bits denote one of three positions in an encryption key sequence.

6. The method of claim 1, wherein the generating includes:
encrypting at least a portion of the data unit with a current encryption key or with a new encryption key in accordance with a state of the two bits before the transmitting.

7. A method of retrieving security information in a media access control (MAC) header by a wireless station, comprising:
receiving a data unit including the MAC header from a remote wireless station; and
reading two encryption key sequence (EKS) bits in the MAC header that denote both whether the data unit is encrypted and a position in an encryption key sequence for the data unit.

8. The method of claim 7, wherein the data unit is a MAC protocol data unit (MPDU).

9. The method of claim 7, wherein the MAC header does not include a separate encryption (EC) bit whose state denotes whether the data unit is encrypted.

10. The method of claim 7, wherein one of four possible states of the two EKS bits indicates that the data unit is unencrypted; and
reading a payload of the data unit as plaintext when the two EKS bits have the one of the four possible states.

11. The method of claim 7, wherein three of four possible states of the two EKS bits denote one of three positions in an encryption key sequence.

12. The method of claim 7, further including:
decrypting the data unit with a current encryption key or with a new encryption key in accordance with a state of the EKS two bits.

13. A wireless station, comprising:
a media access control (MAC) module arranged to generate or parse a protocol data unit (PDU) including a MAC header:
that includes two encryption key sequence (EKS) bits that denote both whether the PDU is encrypted and an encryption key sequence for the PDU, and
that does not include an encryption (EC) bit that is separate from the EKS bits; and
a physical layer (PHY) module arranged to send the PDU to the MAC module or to receive the PDU from the MAC module.

14. The wireless station of claim 13, wherein the MAC module is further arranged to encrypt or decrypt the PDU in accordance with a state of the two EKS bits.

15. The wireless station of claim 13, wherein the MAC module is further arranged to read unencrypted data directly from a payload of the PDU in accordance with a state of the two EKS bits.

16. The wireless station of claim 13, further comprising:
an antenna coupled to the PHY module to wirelessly transmit or receive a signal including information in the PDU.

17. The wireless station of claim 13, wherein one of four possible states of the two EKS bits indicates that the PDU is unencrypted, and
wherein another three of the four possible states of the two EKS bits denote one of three positions in an encryption key sequence.
